(19) United States
(12) Patent Application Publication
(10) Pub. No.: US 2009/0225964 A1
(43) Pub. Date: Sep. 10, 2009

(54) METHOD, SYSTEM AND DEVICE FOR INQUIRING A TELEPHONE BOOK

(75) Inventors: Zhou YU, Shenzhen (CN); Yuetao MENG, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/463,004

(22) Filed: May 8, 2009

Related U.S. Application Data
(63) Continuation of application No. PCT/CN2007/071023, filed on Nov. 6, 2007.

(30) Foreign Application Priority Data
Nov. 8, 2006 (CN) 200610063550.3

(51) Int. Cl. H04M 11/00

(52) U.S. Cl. 379/93.01

(57) ABSTRACT

The invention provides a method and system for inquiring a telephone book and a SIP terminal as well as a SIP server. The method includes: determining requested telephone book information according to an inquiry condition included in an inquiry request, when receiving the inquiry request transmitted from a SIP terminal through SIP; and transmitting an inquiry result including the telephone book information to the SIP terminal through SIP. The invention has better openness and higher reliability by transmitting the inquiry request including the inquiry condition and returning the inquiry result though a general SIP.

### CROSS REFERENCE

This application is a continuation of International Application No. PCT/CN2007/071023, filed on Nov. 6, 2007, titled “Method, System and Device for Inquiring a Telephone Book”, which claims the priority of CN application No. 200610063550.3, filed on Nov. 8, 2006, titled “Method, System and Device for Inquiring a Telephone Book”, the entire contents of all of which are incorporated herein by reference.

### FIELD OF THE INVENTION

The present invention relates to the technical filed of Session Initiation Protocol (SIP), and in particular to a method, system and device for inquiring a telephone book based on SIP.

### BACKGROUND

PC instant messaging software, SIP telephone and wireless SIP terminal are more and more widely used in the field of corporate communication. A corporate telephone book service allows a user to conveniently search for a dial number on the SIP terminal. Based on a keyword or a filter condition input by the user, the SIP terminal may dial a returned telephone number that is matched rapidly. In this manner, the corporate user may rapidly phone his colleagues, clients or partners without the complicated dialing procedure.

In the prior art, the SIP terminal interacts with a telephone book server through a specific protocol between the SIP terminal and the telephone book server, so as to inquire the telephone book. FIG. 1 illustrates a schematic diagram of telephone book inquiry according to the prior art. As shown in FIG. 1, when a user wants to inquire a number, the SIP terminal transmits a request to the telephone book server through the specific protocol and submits an inquiry condition. The telephone book server determines inquiry result and returns a resulting list of telephone numbers through the specific protocol as well. The user selects a telephone number according to the returned list of telephone numbers and dials the number using the SIP terminal. Here, the specific protocol is a private protocol negotiated between the SIP terminal and the telephone book server for inquiring the telephone book; and the SIP terminal may be a SIP phone.

As stated above, when implementing the corporate telephone book service by the existing SIP terminal, the interaction between the SIP terminal and the telephone book server must go through the specific protocol. Thus, the SIP phone and the telephone book server must both support the protocol, which results in low openness of the system.

### SUMMARY

An embodiment of the invention provides a method for inquiring a telephone book, so as to improve the openness of the system.

An embodiment of the invention further provides a system for inquiring a telephone book, so as to improve the openness of the system.

An embodiment of the invention further provides a SIP terminal, so as to improve the openness of the system.

An embodiment of the invention further provides a SIP server, so as to improve the openness of the system.

An embodiment of the invention provides a method for inquiring a telephone book, the method including:

determining requested telephone book information according to an inquiry condition included in an inquiry request, when receiving the inquiry request transmitted from a Session Initiation Protocol (SIP) terminal through SIP; and

transmitting an inquiry result including the telephone book information to the SIP terminal through SIP.

An embodiment of the invention provides a system for inquiring a telephone book, the system including: a SIP terminal, a SIP server and a storage device;

the SIP terminal is adapted to transmit an inquiry request to the SIP server and receive an inquiry result transmitted from the SIP server through SIP;

the SIP server is adapted to receive the inquiry request transmitted from the SIP terminal, obtain requested telephone book information from the storage device according to an inquiry condition included in the inquiry request, and transmit an inquiry result including the telephone book information to the SIP terminal through SIP; and

the storage device is adapted to store telephone book information.

An embodiment of the invention provides a SIP terminal. The SIP terminal includes a request generation unit and a transceiver unit;

the request generation unit is adapted to generate an inquiry request including an inquiry condition and provide the inquiry request to the transceiver unit; and

the transceiver unit is configured to receive the inquiry request provided by the request generation unit, transmit the inquiry request and receive telephone book information transmitted from a SIP server through SIP.

An embodiment of the invention provides a SIP server. The SIP server includes a transceiver unit, an obtaining unit and an inquiry result generation unit;

the transceiver unit is adapted to receive an inquiry request and transmit the inquiry request to the obtaining unit, and transmit an inquiry result provided by the inquiry result generation unit through SIP;

the obtaining unit is adapted to receive the inquiry request transmitted from the transceiver unit, obtain requested telephone book information according to the inquiry request, and provide the telephone book information to the inquiry result generation unit; and

the inquiry result generation unit is adapted to receive the telephone book information provided by the obtaining unit, and generate the inquiry result including telephone book information to provide to the transceiver unit.

It can be seen from the above technical solutions that in the method, system and device for inquiring a telephone book according to embodiments of the present invention, the interaction is achieved by a general SIP transmitting an inquiry request carrying an inquiry condition and receiving an inquiry result, rather than transmitting the inquiry request and inquiry result through the specific protocol between the SIP terminal and the SIP server, as in the prior art. As a result, the telephone book inquiry may be achieved between any SIP-supported terminal and SIP server. Therefore, the method, system and device according to embodiments of the invention have better openness.

### BRIEF DESCRIPTION OF THE DRAWINGS

FIG. 1 is a schematic diagram of telephone book inquiry according to the prior art;

FIG. 2 is a flow chart of a method for inquiring a telephone book according to an embodiment of the invention;

FIG. 3 is a flow chart of a method for paging the inquiry result according to an embodiment of the invention;

FIG. 4 is a flow chart of a method for carrying the inquiry result by media stream according to an embodiment of the invention;

FIG. 5 is an architecture diagram of a system for inquiring a telephone book according to an embodiment of the invention.

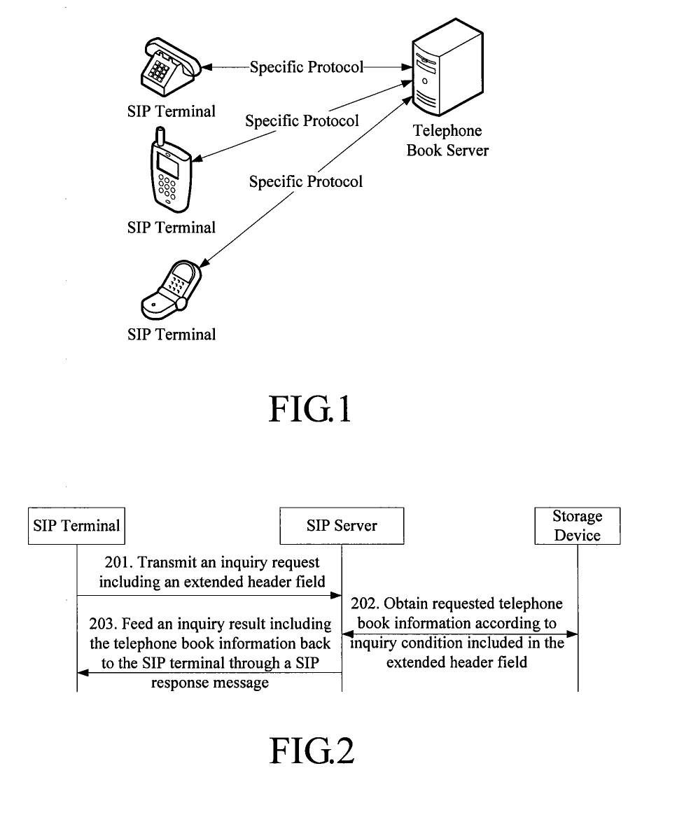

### DETAILED DESCRIPTION

In order to make objects, technical solutions and advantages of the invention more apparent, a further description of the invention is given in detail below with respect to preferred embodiments and the accompanying drawings.

The method for inquiring a telephone book according to an embodiment of the invention includes: determining requested telephone book information according to an inquiry condition included in an inquiry request, when receiving the inquiry request transmitted from a SIP terminal through SIP; and transmitting an inquiry result including the telephone book information to the SIP terminal through SIP.

Each step in the above method is performed by a SIP server. The SIP server may obtain the requested telephone book information from a storage device stored with the telephone book information. The SIP server may alternatively be set as the telephone book server, that is, the SIP server itself saves the telephone book information and determines the requested telephone book information according to the inquiry condition directly. Here, the SIP terminal is a telephone or PC soft phone supporting SIP. The method performs telephone book inquiry by interacting between the SIP terminal and SIP server through SIP.

The SIP request transmitted by the SIP terminal includes an inquiry condition, such as Name, Department, and keyword. The user may input [symbol] or ‘zhangsan’ to the SIP terminal when performing inquiry by Name. The user may input ‘procurement department’ to the SIP terminal when performing inquiry by Department. When performing inquiry by keyword, the user may input ‘zhangsan procurement’ to the SIP terminal. The SIP terminal then transmits the inquiry request including the inquiry condition to the SIP server through SIP. After receiving the inquiry request, the SIP server determines the requested telephone book information according to the inquiry condition and returns the telephone book information. The returned telephone book information may be a list of telephone book records. Upon receiving the telephone book information, the SIP terminal may initiate a call by directly selecting a telephone number record therefrom.

In the above method for inquiring the telephone book, the step of transmitting the inquiry request through SIP and transmitting the telephone book information to the SIP terminal through SIP may be implemented in several ways, which will be described in the following with reference to the embodiments.

FIG. 2 is a flow chart of a method for inquiring a telephone book according to an embodiment of the invention. In the method shown in FIG. 2, the SIP terminal carries the inquiry condition by extending the SIP header field, and the SIP server returns the inquiry result by extending the SIP header field as well. For example, the inquiry request may be carried by adding an extended header field for identifying the user's Name and an extended header field for identifying the Department to the SIP message; and the inquiry result may be carried by adding an extended header field for identifying the phone number to the SIP message. Here, the SIP message may be a specific SIP request or other SIP messages such as a call request (INVITE), an instant message (MESSAGE), capability inquiry information (OPTION), control information transmission message (INFO).

As shown in FIG. 2, the method includes the following steps.

Step 201: the SIP terminal transmits an inquiry request including an extended header field to the SIP server.

Taking the following as an example, which uses extended header fields identifying the user's Name and keyword, and the following inquiry request may be used:

| | |
|---|---|
| OPTIONS sip:172.31.254.2 SIP/2.0 | //message type |
| Via: SIP/2.0/UDP 172.31.4.53:5060 | //recoding the passed network elements |

| | |
|---|---|
| To: <sip:8001@172.31.254.2> | //address of the message receiver |

| | |
|---|---|
| From: <sip:8001@172.31.254.2> | // address of the message sender |

| | |
|---|---|
| Call-ID:1f635748-01d6-0c22-13cc-00e0bb1b7ca3@172.31.4.53 | //Call ID |

| | |
|---|---|
| CSeq: 1 OPTIONS | //sequence number of the message packet |

| | |
|---|---|
| Contact: <sip:8001@172.31.4.53:5060> | //contactable address of the sender |

| | |
|---|---|
| P-UsrName: zhangsan (or [symbol] ) | //extended header field |

| | |
|---|---|
| P-Keyword: zhangsan procurement | // extended header field |
| ... ... | |

| | |
|---|---|
| Content-Length: n | // length of the message packet |

In the example of the inquiry request, the extended header field of ‘P-UserName: zhangsan’ for identifying the user's name and the extended header field of ‘P-Keyword: zhangsan procurement’ for identifying the keyword are used.

Step 202: Upon receiving the inquiry request from the SIP terminal, the SIP server obtains the requested telephone book information according to the inquiry condition carried in the extended header field.

The search may be implemented by the SIP server obtaining the requested telephone book information from other devices stored with the telephone book information, or by the SIP server that is stored with the telephone book information by itself determining the requested telephone book information according to the inquiry condition directly.

Step 203: The inquiry result including the telephone book information is fed back to the SIP terminal through a SIP response message. Here, the SIP response message may also carry the inquiry result by using an extended header field accordingly.

The response message through which the SIP server feeds back the inquiry request may be:

| | |
|---|---|
| SIP/2.0 200 OK | //success response of a call |
| Via: SIP/2.0/UDP 172.31.4.53 | //recording the passed network elements |
| From: <sip:8001@172.31.254.2> | //address of the message sender |

| | |
|---|---|
| To: <sip:8001@172.31.254.2>;tag=82080ac | // address of the message receiver |

| | |
|---|---|
| Call-ID: 1f635748-01d6-0c22-13cc-00e0bb1b7ca3@172.31.4.53 | //call ID |

| | |
|---|---|
| Cseq: 1 OPTIONS | //sequence number of the message packet |

| | |
|---|---|
| Date: Sat, 26 Aug 2006 14:09:41 GMT | //date |
| Contact: <sip: 8001@172.31.254.2> | //contactable address of the sender |

| | |
|---|---|
| P-TelNo: 0571-12345678 | // extended header field for telephone number |

| | |
|---|---|
| P-TelNo: 0571-87654321 | //in case of a plurality of telephone numbers |

| | |
|---|---|
| P-UsrName: zhangsan | //extended header field for user name |

| | |
|---|---|
| P-Dept: procurement department | // extended header field for department |
| ...... | |

| | |
|---|---|
| Content-Length: n | // length of the message |

In the example of the response message including the inquiry result, the extended header fields ‘P-TelNo: 0571-12345678’, ‘P-TelNo: 0571-87654321’ for identifying the telephone numbers are used. When there is a plurality of telephone numbers, the telephone numbers may be arranged repeatedly by order, or in other agreed way.

Besides carrying the inquiry condition and inquiry result with extended header field in the SIP message, the inquiry condition and inquiry result may also be carried by using extended tag of the header field in the SIP message. That is, a tag for identifying field type may be added after the SIP header. Here, the extended tag is not limited to be used in a specific SIP header field.

An inquiry request that carries the inquiry result by using an extended tag of the SIP header field may be:

OPTIONS sip:172.31.254.2 SIP/2.0
Via: SIP/2.0/UDP 172.31.4.53:5060
To: <sip:8001@172.31.254.2>
From: <sip:8001@172.31.254.2>; P-UsrName=zhangsan (or [symbol] )

// extended tag

Call-ID: 1f635748-01d6-0c22-13cc-00e0bb1b7ca3@172.31.4.53
CSeq: 1 OPTIONS
Contact: <sip:8001@172.31.4.53:5060>
......
Content-Length: 0

In the message, the extended tag of ‘P-UsrName=zhangsan’ is carried in the header field of ‘From: <sip:8001@172.31.254.2>’.

Accordingly, a response message used by the SIP server to carry the inquiry result by using an extended tag of the SIP header field may be:

SIP/2.0 200 OK
Via: SIP/2.0/UDP 172.31.4.53
From: <sip:8001@172.31.254.2>
To: <sip:8001@172.31.254.2>; tag=82080ac; P-TelNo=0571-12345678

// extended tag

Call-ID: 1f635748-01d6-0c22-13cc-00e0bb1b7ca3@172.31.4.53
Cseq: 1 OPTIONS
Date: Sat, 26 Aug 2006 14:09:41 GMT
Contact: <sip: 8001@172.31.254.2>
......
Content-Length: 0

In the response message, the extended tag of ‘P-TelNo=0571-12345678’ is carried in the header field of ‘To: <sip:8001@172.31.254.2>; tag=82080ac;’.

When the above method applying the extended SIP header field or the extended tag of the SIP header field is used, the SIP server needs to check the received message each time receiving a message and determines whether the message carries an inquiry request, which results in low inquiry efficiency. Thus, the SIP message type may be extended by using customized SIP message, such as using extended telephone number inquiry request (REQTEL), such that the SIP server only inquires with respect to the specific SIP message, so as to improve the inquiry efficiency.

In the following, taking the REQTEL message as an example, an inquiry request transmitted by using the customized message may be:

REQTEL sip:172.31.254.2 SIP/2.0
Via: SIP/2.0/UDP 172.31.4.53:5060
To: <sip:8001@172.31.254.2>
From: <sip:8001@172.31.254.2>
Call-ID: 1f635748-01d6-0c22-13cc-00e0bb1b7ca3@172.31.4.53
CSeq: 1 REQTEL
Contact: <sip:8001@172.31.4.53:5060>
P-UsrName: zhangsan (or [symbol] )
P-Keyword: zhangsan procurement
......

The REQTEL message includes the header fields of ‘P-UserName: zhangsan’ and ‘P-Keyword: zhangsan procurement ’.

A response message returned from the SIP server by using REQTEL may be:

SIP/2.0 200 OK
Via: SIP/2.0/UDP 172.31.4.53
From: <sip:8001@172.31.254.2>
To: <sip:8001@172.31.254.2>;tag=82080ac
Call-ID: 1f635748-01d6-0c22-13cc-00e0bb1b7ca3@172.31.4.53
Cseq: 1 REQTEL
Date: Sat, 26 Aug 2006 14:09:41 GMT
Contact: <sip: 8001@172.31.254.2>
P-TelNo: 0571-12345678
P-TelNo: 0571-87654321
P-UsrName: zhangsan
P-Dept: procurement department
......
Content-Length: n

The REQTEL message includes the header fields of ‘P-TelNo: 0571-12345678’, ‘P-TelNo: 0571-87654321’, ‘P-UsrName: zhangsan’, ‘P-Dept: procurement department’.

Furthermore, the inquiry condition and inquiry result may also be carried by extending the SIP message body. It may be specified in the Content-Type header field (Content-Type) of the SIP message that the message body is telephone book records (application/Tel-Info). The format of the message body may be eXtensible Markup Language (XML), XML Configuration Access Protocol (XCAP), Light Directory Access Protocol (LDAP) Data Interchange Format (LDIF), or other formats that may express the telephone book information. The inquiry request and inquiry result may be transmitted in the message body. The SIP message body may be extended by using existing standard SIP message types, such as INVITE, OPTION, MESSAGE; it may also be combined with method for extending the SIP message type of REQTEL. In the following, taking the REQTEL message type as an example, an inquiry request that carries the inquiry condition by using the extended SIP message body may be:

| REQTEL sip:172.31.254.2 SIP/2.0 | |
|---|---|
| Via: SIP/2.0/UDP 172.31.4.53:5060 | |
| To: <sip:8001@172.31.254.2> | |
| From: <sip:8001@172.31.254.2> | |
| Call-ID: 1f635748-01d6-0c22-13cc-00e0bb1b7ca3@172.31.4.53 | |
| CSeq: 1 REQTEL | |
| Contact: <sip:8001@172.31.4.53:5060> | |
| Content-Type: application/Tel-Info | //indicating that the message |

body type is telephone book record

Content-Length: 23
<UDL>
<NAME>zhangsan</NAME>
</UDL>

And the response message that carries the inquiry result by using the extended SIP message body may be:

| SIP/2.0 200 OK | |
|---|---|
| Via: SIP/2.0/UDP 172.31.4.53 | |
| From: <sip:8001@172.31.254.2> | |
| To: <sip:8001@172.31.254.2>;tag=82080ac | |
| Call-ID: 1f635748-01d6-0c22-13cc-00e0bb1b7ca3@172.31.4.53 | |
| Cseq: 1 REQTEL | |
| Date: Sat, 26 Aug 2006 14:09:41 GMT | |
| Contact: <sip: 8001@172.31.254.2> | |
| Content-Type: application/Tel-Info | //indicating that the message |

body type is telephone book record

Content-Length: 78
<UDL>

<Element>

<NAME>zhangsan</NAME>
<Dept>procurement department</Dept>
<Telno>0571-12345678</Telno>
<Telno>0571-87654321</Telno>
</Element>

<Element>

<NAME>zhangsan</NAME>
<Dept>production department</Dept>
<Telno>0571-56781234</Telno>
<Telno>0571-43218765</Telno>
</Element>

......

</UDL

When the telephone book information transmitted from the SIP server to the SIP terminal exceeds size limit of the SIP packet, two methods may be used to resolve it. One is to page the inquiry result. The other is to carry the inquiry result by using media stream. The two methods will be described in the following with reference to the embodiments.

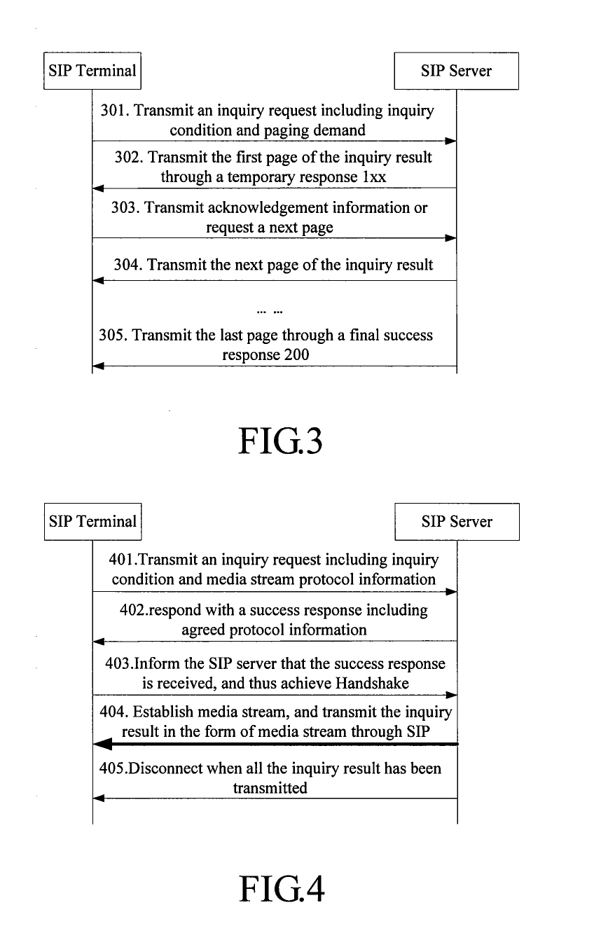

FIG. 3 is a flow chart of a method for paging the inquiry result according to an embodiment of the invention. The method may transmit previous pages of the inquiry result through a temporary response 1xx, and transmit the last page of the inquiry result through a success response 200. As shown in FIG. 3, the method includes the following steps.

Step 301: The SIP terminal transmits to the SIP server an inquiry request, which includes the inquiry condition and the paging demand.

At this step, transmitting the inquiry request may be done by using the extended SIP header field, the extended tag of the SIP message, the extended SIP message body or the extended SIP message type etc., as discussed in the above embodiments.

The paging demand may be a page size, and the SIP server may return corresponding paging information according to the page size. The paging demand may also be a start line number, and the SIP server may return paging information meeting the demand of start line number.

Step 302: The SIP server transmits to the SIP terminal the first page of the inquiry result through a temporary response 1xx.

In this embodiment, the telephone book information is stored in the SIP server itself, for example.

Step 303: The SIP terminal transmits acknowledgement information to the SIP server, or requests the next page of the inquiry result.

Step 304: The SIP server transmits to the SIP terminal the next page of the inquiry result.

Steps 303 and 304 are repeated until the last page.

Step 305: The SIP server transmits the last page of the inquiry result to the SIP terminal through a final success response 200.

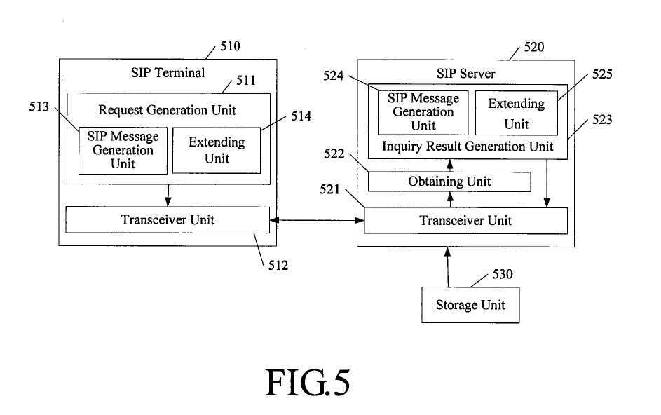

FIG. 4 is a flow chart of a method for carrying the inquiry result by media stream according to an embodiment of the invention. As shown in FIG. 4, the method includes the following steps.

Step 401: The SIP terminal transmits to the SIP server an inquiry request, which includes the inquiry condition and media stream protocol information.

At this step, transmitting the inquiry request may be done by using the extended SIP header field, the extended tag of the SIP message, the extended SIP message body or the extended SIP message type etc., as discussed in the above embodiments.

The media stream protocol information may include information such as protocols used for transmitting the media stream, port used for transmission etc.

Step 402: The SIP server responds with a success response, which includes the protocol information that the SIP server agrees.

Step 403: The SIP terminal informs the SIP server that the success response has been received, and thus Handshake is achieved.

Step 404: Media stream is established between the SIP terminal and the SIP server, and the SIP server transmits the inquiry result to the SIP terminal in the form of media stream.

At this step, protocols that can ensure the transmission of integrate information, such as File Transfer Protocol (FTP), Hypertext Transfer Protocol (HTTP), may be used as protocols for transmitting the media streams.

Step 405: After the inquiry result has all been transmitted, the SIP server transmits a disconnection request to the SIP server to disconnect the media stream connection.

The above is a description of the method for inquiring the telephone book according to an embodiment of the invention. In the following, the system for inquiring the telephone book according to an embodiment of the invention will be described. FIG. 5 is an architecture diagram of the system for inquiring the telephone book according to an embodiment of the invention. The system mainly includes: a SIP terminal 510, a SIP server 520 and a storage device 530.

The SIP terminal 510 is adapted to transmit an inquiry request to the SIP server 520 and receive inquiry result transmitted from the SIP server through SIP.

The SIP server 520 is adapted to receive the inquiry request transmitted from the SIP terminal 510 and obtain the requested telephone book information from the storage device 530 according to inquiry condition included in the inquiry request, and transmit the inquiry result including the telephone book information to the SIP terminal 510 through SIP.

The storage device 530 is adapted to store the telephone book information.

Here, the storage device 530 may be separately configured or be configured in the SIP server 520.

Here, the SIP terminal 510 mainly includes a request generation unit 511 and a transceiver unit 512.

The request generation unit 511 is adapted to generate the inquiry request including the inquiry condition and provide the inquiry request to the transceiver unit 512.

The transceiver unit 512 is adapted to receive the inquiry request provided by the request generation unit 511, transmit the inquiry request through SIP, and receive the telephone book information transmitted from the SIP server 520.

Here, the request generation unit 511 may include a SIP message generation unit 513 and an extending unit 514.

The SIP message generation unit 513 is adapted to generate the SIP message for transmission to the SIP server 520 and provide the SIP message to the extending unit 514.

The extending unit 514 is adapted to receive the SIP message provided by the SIP message generation unit 513 and perform processing such as extending SIP header field, extending tag of SIP message, extending SIP message body or extending SIP message type on the SIP message, so as to obtain the inquiry request including the inquiry condition, and provide the inquiry request to the transceiver unit 512.

The extending unit 514 may use the methods for extending the SIP message, as discussed in FIG. 2, FIG. 3 or FIG. 4.

The SIP server 520 may include a transceiver unit 521, an obtaining unit 522 and an inquiry result generation unit 523.

The transceiver unit 521 is adapted to receive the inquiry request and transmit the inquiry request to the obtaining unit 522, and transmit the inquiry request provided by the inquiry result generation unit 523 through SIP.

The obtaining unit 522 is adapted to receive the inquiry request transmitted from the transceiver unit 521, obtain the requested telephone book information according to the inquiry request, and provide the telephone book information to the inquiry result generation unit 523.

The inquiry result generation unit 523 is adapted to receive the telephone book information provided by the obtaining unit 522, and generate the inquiry result including the telephone book information to provide to the transceiver unit 521.

Here, the inquiry result generation unit 523 includes a SIP message generation unit 524 and an extending unit 525.

The SIP message generation unit 524 is adapted to generate the SIP message for transmission to the SIP terminal 510 and provide the SIP message to the extending unit 525.

The extending unit 525 is adapted to receive the SIP message provided by the SIP message generation unit 524 and the telephone book information provided by the obtaining unit 522, and perform processing such as extending SIP header field, extending tag of SIP message, extending SIP message body or extending SIP message type on the SIP message so as to obtain the inquiry result including the telephone book information, and provide the inquiry result to the transceiver unit 521.

The extending unit 525 may use the methods for extending the SIP message, as discussed in FIG. 2, FIG. 3 or FIG. 4.

It can be seen from the above technical solutions that in the method, system and device for inquiring a telephone book according to embodiments of the present invention, a general SIP may be used to transmit an inquiry request carrying an inquiry condition and receive an inquiry result, rather than transmitting the inquiry request and inquiry result through a specific protocol between a SIP terminal and a SIP server, as in the prior art. Therefore, the method, system and device according to embodiments of the invention have better openness.

The method and system according to embodiments of the invention carry the inquiry condition and inquiry result by using the extended SIP header field, the extended tag of SIP header field, the extended SIP message body or the extended SIP message type. While the specific protocol between the SIP terminal and the telephone book server in the prior art is just negotiated to realize the telephone book inquiry, which is generally defined simply and casually. Therefore, the method, system and device according to embodiments of the invention are more reliable with relative to those of the prior art.

The method, system and device according to embodiments of the invention may transmit the inquiry result by paging processing or through media stream, which solves the problem of the inquiry result exceeding the size limitation of the SIP packet. In particularly, it avoids the concerns of packet policy, receiving response, integrity insurance etc. involved in the packet procedure and it is easy to implement when media stream is used to transmit the inquiry result.

The above is only exemplary embodiments of the present invention, and it is not intended to limit the scope of the disclosure. Any modification, equivalent substitution and improvement within the spirit and scope of the disclosure are intended to be included in the scope of the disclosure.

1. A method for inquiring a telephone book comprising:
determining requested telephone book information according to an inquiry condition included in an inquiry request, when receiving the inquiry request transmitted from a Session Initiation Protocol (SIP) terminal through SIP; and
transmitting an inquiry result including the telephone book information to the SIP terminal through SIP.

2. The method of claim 1, wherein determining requested telephone book information according to an inquiry condition included in an inquiry request comprises:
obtaining the telephone book information that meets the inquiry condition from a storage device stored with telephone book information, according to the inquiry condition.

3. The method of claim 1, wherein determining requested telephone book information according to an inquiry condition included in an inquiry request comprises:
determining, by a SIP server, the telephone book information that meets the inquiry condition from telephone book information stored in itself, according to the inquiry condition.

4. The method of claim 1, wherein the inquiry request is a SIP message;
the inquiry condition is included in an extended header field of the SIP message, or in an extended tag of a SIP header field of the SIP message, or in an extended message body of the SIP message.

5. The method of claim 1, wherein the inquiry request is a SIP message;
the inquiry condition is transmitted by being included in a SIP message obtained by extending a SIP message type.

6. The method of claim 1, wherein the inquiry result is transmitted by being included in an extended header field of the SIP message, or in an extended tag of a SIP header field of the SIP message, or in an extended message body of the SIP message.

7. The method of claim 4, wherein the SIP message is a call request INVITE, an instant message MESSAGE, capability inquiry information OPTION, control information transmission message INFO or a SIP message with extended SIP message type.

8. The method of claim 1, wherein the inquiry result is transmitted by being included in a SIP message obtained by extending SIP message type, or transmitted in the form of media stream.

9. The method of claim 1, wherein the inquiry condition includes a paging demand; and
transmitting an inquiry result including the telephone book information to the SIP terminal through SIP comprises:
including the inquiry result except for the last page in a SIP temporary response to transmit to the SIP terminal, according to the paging demand; and
including the last page of the inquiry result in a SIP success response to transmit to the SIP terminal.

10. A system for inquiring a telephone book comprising a SIP terminal, a SIP server and a storage device, wherein
the SIP terminal is adapted to transmit an inquiry request to the SIP server and receive an inquiry result transmitted from the SIP server through SIP;
the SIP server is adapted to receive the inquiry request transmitted from the SIP terminal, obtain requested telephone book information from the storage device according to an inquiry condition included in the inquiry request, and transmit an inquiry result including the telephone book information to the SIP terminal through SIP; and
the storage device is adapted to store telephone book information.

11. The system of claim 10, wherein the storage device is a separate device, or it is configured in the SIP server.

12. A SIP terminal comprising a request generation unit and a transceiver unit, wherein
the request generation unit is adapted to generate an inquiry request including an inquiry condition and provide the inquiry request to the transceiver unit; and
the transceiver unit is configured to receive the inquiry request provided by the request generation unit, transmit the inquiry request and receive telephone book information transmitted from a SIP server through SIP.

13. The SIP terminal of claim 12, wherein the request generation unit comprises a SIP message generation unit and an extending unit;
the SIP message generation unit is adapted to generate a SIP message for transmission to the SIP server and provide the SIP message to the extending unit; and
the extending unit is adapted to receive the SIP message provided by the SIP message generation unit, perform processing as extending SIP header field or extending tag of SIP message or extending SIP message body or extending SIP message type on the SIP message to obtain the inquiry request including the inquiry condition, and provide the inquiry request to the transceiver unit.

14. A SIP server comprising a transceiver unit, an obtaining unit and an inquiry result generation unit, wherein
the transceiver unit is adapted to receive an inquiry request and transmit the inquiry request to the obtaining unit, and transmit an inquiry result provided by the inquiry result generation unit through SIP;
the obtaining unit is adapted to receive the inquiry request transmitted from the transceiver unit, obtain requested telephone book information according to the inquiry request, and provide the telephone book information to the inquiry result generation unit; and
the inquiry result generation unit is adapted to receive the telephone book information provided by the obtaining unit, and generate the inquiry result including telephone book information to provide to the transceiver unit.

15. The SIP server of claim 14, wherein the inquiry result generation unit comprises a SIP message generation unit and an extending unit;
the SIP message generation unit is adapted to generate a SIP message for transmission to the SIP terminal and provide the SIP message to the extending unit; and
the extending unit is adapted to receive the SIP message provided by the SIP message generation unit and the telephone book information provided by the obtaining unit, perform processing as extending SIP header field or extending tag of SIP message or extending SIP message body or extending SIP message type on the SIP message to obtain the inquiry result including the telephone book information, and provide the inquiry result to the transceiver unit.

16. The SIP server of claim 14, wherein the SIP server further comprises a storage unit for storing telephone book information; and
the obtaining unit obtains requested telephone book information from the storage unit.

17. The method of claim 6, wherein the SIP message is a call request INVITE, an instant message MESSAGE, capability inquiry information OPTION, control information transmission message INFO or a SIP message with extended SIP message type.
